(19) United States
(12) Patent Application Publication
(10) Pub. No.: US 2026/0369978 A1
(43) Pub. Date: Nov. 19, 2026

(54) SUPPORT CLIP FOR ELECTRICAL BOXES

(71) Applicant: ERICO International Corporation, Solon, OH (US)

(72) Inventors: Lauren Novak, Strongsville, OH (US); Nathan Joseph Petek, Chagrin Falls, OH (US)

(21) Appl. No.: 19/647,517

(22) Filed: Apr. 14, 2026

Related U.S. Application Data
(60) Provisional application No. 63/808,151, filed on May 19, 2025.

(51) Int. Cl. H02G 3/12

(52) U.S. Cl. CPC H02G 3/125

(57) ABSTRACT

A support clip to secure an electrical box can include a clip body having catch members and spring arms. The catch members can be resiliently movable to extend through mounting openings of the electrical box and engage catches of the catch members with an interior side of a back wall of the electrical box. The spring arms can include seating surfaces oriented to resiliently urge the catches into the interior side of the back wall.

### CROSS-REFERENCE TO RELATED APPLICATIONS

This application claims priority to U.S. Provisional Patent Application No. 63/808,151, filed May 19, 2025, the entirety of which is incorporated herein by reference.

### BACKGROUND

In many applications, it may be useful to support and secure electrical boxes and other components. For example, in some instances, electrical boxes may be required to be secured within a ceiling structure at particular distances from certain other structures or components.

### SUMMARY

Aspects of the present disclosure can provide a support clip to secure an electrical box. The electrical box can include a back wall with mounting openings. The support clip can include a clip body having opposed first and second lateral edges and a top side. The support clip can include first and second catch members integral with the clip body. The first catch member can extend laterally outwardly and downwardly from the first lateral edge of the clip body. The second catch member can extend laterally outwardly and downwardly from the second lateral edge of the clip body. The first and second catch members can each include a free end with a catch that extends laterally inwardly toward the clip body. The first and second catch members can each be resiliently movable relative to the clip body between rest orientations and installation orientations. This can allow the free end to extend through the mounting openings of the electrical box and engage the catch with an interior side of the back wall of the electrical box. The support clip can include first and second spring arms integral with the clip body. The first spring arm can extend laterally outwardly and downwardly from the first lateral edge of the clip body to a first downwardly-facing seating surface. The second spring arm can extend laterally outwardly and downwardly from the second lateral edge of the clip body to a second downwardly-facing seating surface. The first and second seating surfaces can be aligned to seat on an exterior side of the back wall of the electrical box. This can resiliently engage the first and second spring arms with the exterior side of the back wall of the electrical box when the catches of the first and second catch members engage the interior side of the back wall of the electrical box.

In some examples, each of the first and second catch members can include a support arm portion angling laterally outwardly and downwardly away from the corresponding first or second lateral edge of the clip body. Each of the first and second catch members can include a catch arm portion that extends downwardly from the support arm portion, at a bend in the corresponding first or second catch member. The catch arm portion can include the catch of the corresponding first or second catch member.

In some examples, for each of the first and second catch members, the catch arm portion can include a rib that extends between the bend and the free end.

In some examples, each of the first and second catch members can include a shoulder disposed above the catch. The shoulder can be configured to provide a stop against insertion of the free end into the corresponding mounting opening past a maximum insertion depth.

In some examples, the seating surfaces can curve upwardly toward free ends of the first and second spring arms.

In some examples, the catches can be barbs that angle upwardly toward the clip body from the free end of the corresponding first or second catch member.

In some examples, the first and second spring arms and the clip body can define a support channel configured to receive a support bar to support the support clip relative to gravity. The catches can support the electrical box relative to the support clip. The first and second spring arms can include protrusions that extend laterally inwardly to engage the support bar within the support channel.

In some examples, the first and second spring arms and the clip body can define a support channel configured to receive a support bar to support the support clip relative to gravity with the catches supporting the electrical box. The support clip can further include locking tabs that extend integrally from the clip body to resiliently engage the support bar when the support bar is received into the support channel.

In some examples, the locking tabs can angle downwardly relative to the clip body so as to be oriented to resiliently engage with top surfaces of the support bar.

In some examples, the clip body can further include a thread impression configured to receive a threaded rod to hang the support clip from the threaded rod.

In some examples, the first and second spring arms can extend from a spring-arm portion of the clip body. The first and second catch members can extend from a catch-member portion of the clip body. The clip body can define a relief region between the spring-arm portion and the catch-member portion to provide a flex line for upward flexing of the spring-arm portion relative to the catch-member portion.

In some examples, the first spring arm can be included in a first plurality of spring arms that extend from the first lateral edge of the clip body on opposite sides of the first catch member. The second spring arm can be included in a second plurality of spring arms that extend from the second lateral edge of the clip body on opposite sides of the second catch member.

Aspects of the present disclosure can provide a support clip to secure an electrical box. The electrical box can include a back wall with mounting openings. The support clip can include a clip body having opposed first and second lateral sides and a top side. The support clip can include catch members integral with the clip body and extending laterally outwardly and downwardly from the first and second lateral sides. The catch members can include catches that extend laterally inwardly from free ends of the catch members. The catch members can be resiliently movable between rest orientations and installation orientations. This can allow the catch members to extend through the mounting openings of the electrical box and engage the catches with an interior side of the back wall of the electrical box to support the electrical box. The support clip can include spring arms integral with the clip body and extending laterally outwardly and downwardly from the first and second lateral sides. The spring arms can include downwardly-facing seating surfaces oriented to seat on an exterior side of the back wall of the electrical box to resiliently urge the catches into the interior side of the back wall of the electrical box.

In some examples, the catch members can include a first catch member extending from the first lateral side of the clip body and a second catch member extending from the second lateral side of the clip body. The spring arms can include a first set of spring arms extending from the first lateral side of the clip body on opposite sides of the first catch member. The spring arms can include a second set of spring arms extending from the second lateral side of the clip body on opposite sides of the second catch member.

In some examples, the seating surfaces of the spring arms can be oriented to engage the exterior side of the back wall of the electrical box at locations laterally inward from the catches, between the catches and the clip body.

In some examples, the support clip can define a support channel configured to receive a support bar to support the support clip relative to gravity while the catches support the electrical box. The support clip can further include locking tabs that extend downwardly to overlap with the support channel. The locking tabs can biasingly urge the clip body upwardly away from the support bar when the support bar is received into the support channel.

In some examples, the clip body can define a closed side of a support channel configured to receive a support bar to support the support clip relative to gravity with the catches supporting the electrical box. The clip body can further include a thread impression configured to receive a threaded rod to hang the support clip from the threaded rod.

In some examples, the catch members can angle downwardly from the clip body to a respective bend and extend downwardly from the respective bend to the corresponding catches. The catches can angle upwardly toward the clip body from the free end of the corresponding catch member.

Aspects of the present disclosure can provide a method of installing an electrical box. The method can include providing a support clip. The support clip can include a clip body having opposed first and second lateral sides and a top side. The support clip can include catch members integral with the clip body and extending laterally outwardly and downwardly from the first and second lateral sides. The catch members can include catches that extend laterally inwardly from free ends of the catch members. The support clip can include spring arms integral with the clip body and extending laterally outwardly and downwardly from the first and second lateral sides. The spring arms can include downwardly-facing seating surfaces. The method can include decreasing a distance between the support clip and the electrical box along an insertion direction. This can resiliently move the catch members between rest orientations and installation orientations to extend the catch members through mounting openings of a back wall of the electrical box and engage the catches with an interior side of the back wall of the electrical box. This can also seat the seating surfaces on an exterior side of the back wall of the electrical box to resiliently urge the catches into the interior side of the back wall of the electrical box.

In some examples, the support clip can define a support channel and further include locking tabs that extend downwardly to overlap with the support channel. The method can further include moving the support clip to receive a support bar into the support channel to support the support clip relative to gravity. Engaging the catches with the interior side of the back wall of the electrical box to support the electrical box can engage the locking tabs with the support bar to biasingly urge the clip body upwardly away from the support bar.

Other aspects of methods of the present disclosure can include aligning a support clip as disclosed herein with mounting openings of an electrical box, and decreasing a distance between the support clip and the electrical box, along an insertion direction, to insert catches of the support clip into the mounting openings to resiliently secure the support clip to the electrical box.

The method can further include selectively, before resiliently securing the support clip to the electrical box: securing the support clip to a support bar, or securing the support clip to a threaded rod.

### BRIEF DESCRIPTION OF FIGURES

The accompanying drawings, which are incorporated in and form a part of this specification, illustrate embodiments of the invention and, together with the description, serve to explain the principles of embodiments of the invention:

FIGS. 1 and 2 illustrate isometric and reverse views of a support clip for mounting electrical boxes, according to aspects of the present disclosure.

FIG. 3 illustrates an isometric view of the support clip of FIG. 1 in an electrical assembly.

FIG. 4 illustrates an isometric view of the support clip of FIG. 1 in another configuration of the electrical assembly.

FIGS. 5 and 6 illustrate a method of assembly of the electrical assembly of FIG. 4.

FIG. 7A shows a cross-section detail view of the assembly as installed in FIG. 6.

FIG. 7B illustrates a bottom detail view of the installed assembly of FIG. 6.

FIGS. 8A and 8B illustrate elevation and top plan views of an alternate configuration of the support clip of FIGS. 3 and 4, according to aspects of the present disclosure.

FIG. 8C shows an axonometric view of another configuration of the electrical assembly of FIG. 2, with the support clip of FIGS. 8A and 8B.

FIGS. 9 and 10 illustrate isometric and reverse views of another configuration of the support clip of FIGS. 1 and 2, according to some aspects of the disclosure.

FIG. 11 illustrates a front view of the support clip of FIG. 9.

FIG. 12 illustrates an isometric view of the support clip of FIG. 9 in another configuration of the electrical assembly.

FIG. 13 illustrates a cross-sectional partial view of the electrical assembly of FIG. 12 taken along lines XIII-XIII.

FIG. 14 illustrates an isometric view of the support clip of FIG. 9 in another configuration of the electrical assembly.

FIG. 15 illustrates a cross-sectional partial view of the electrical assembly of FIG. 14 taken along lines XV-XV.

FIG. 16 illustrates a detail view of the support clip of FIG. 14.

FIG. 17 illustrates a detail view of a catch of the support clip of FIG. 9 in a rest orientation.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

In different contexts, it may be useful to secure electrical boxes to building structure, including to suspend the electrical boxes in ceiling and other installations. Ceiling-installed electrical assemblies are typically supported by threaded rod or by cross bars that extend between building structures (e.g., T-grid ceiling structures). However, conventional support devices may not be particularly versatile for selective installation in either configuration. Further, conventional support devices may require multiple loose components (e.g., a support body and a separate fastener), which may complicate installation.

Support clips and related systems and methods according to the disclosed technology can address these or other issues. For example, catch arms on a support clip can be spaced to be aligned with corresponding mounting openings on an electrical box (e.g., circular holes, on a rear wall thereof), and can be resiliently deflectable to be easily installed into the mounting openings to secure the electrical box to the support clip. In some examples, a support clip can be first selectively installed onto a support bar or onto a threaded rod, and then an electrical box can be attached to the support clip without additional fasteners, to support the electrical box relative to the support bar or the threaded rod.

Accordingly, the disclosed support clip may provide a versatile and efficient solution for mounting electrical boxes in various configurations. In some cases, the support clip may allow for tool-free installation. Further, different configurations can accommodate different mounting hole patterns, including varied patterns as may be found in standard electrical boxes designed for use in the United States, Canada, or other regions (e.g., with two mounting holes on a rear wall having a pre-set center-to-center spacing).

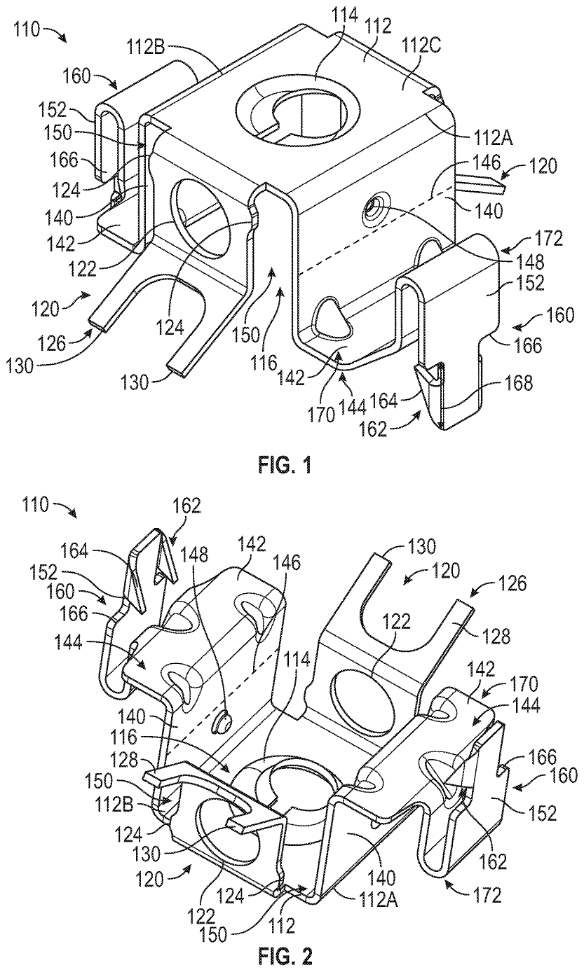

FIG. 1 and FIG. 2 illustrate isometric views of an example configuration of a support clip 110. Generally, the support clip 110 may be integrally formed from spring steel or other suitably resilient material (e.g., spring steel with 0.025-inch thickness). In some cases, the support clip 110 may be heat treated or surface-coated (e.g., for improved strength, corrosion resistance, or other factors). The support clip 110 may include a clip body 112, which may include a first lateral side that includes a first lateral edge 112A, an opposed second lateral side that includes an opposed second lateral edge 112B, and a top side 112C. The clip body 112 may support locking members, configured as locking arms 120 (e.g., cantilevered spring arms), and catch members 160, as further detailed below. In the illustrated example, the locking arms 120 are symmetrically arranged relative to each other, as are the catch members 160. Accordingly, description herein of one of the locking arms 120 (or the catch members 160) generally applies to the other locking arm 120 (or catch member 160). However, other configurations are possible (e.g., with one or more non-symmetrically arranged catch members).

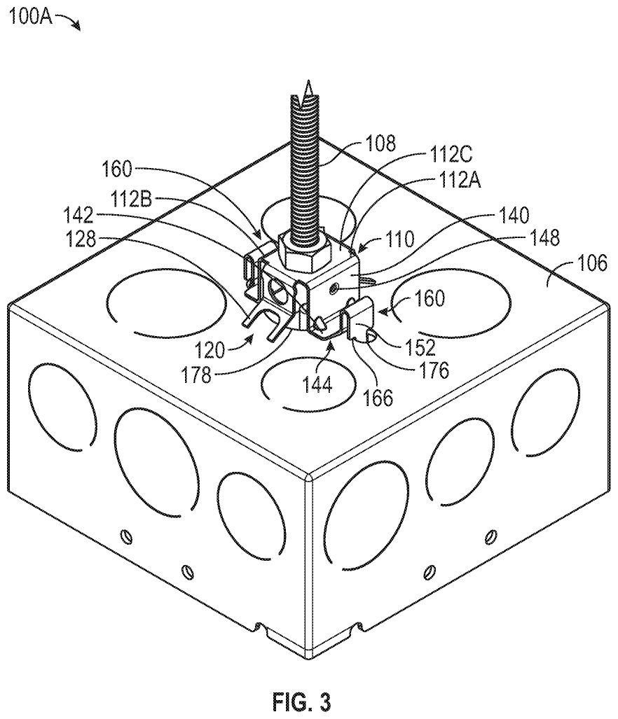

Using features further discussed below, the support clip 110 can be easily installed to support multiple configurations of an electrical assembly. For example, FIG. 3 shows an electrical assembly 100A according to an example of the disclosed technology. The electrical assembly 100A may include the support clip 110 secured to a threaded rod 108, to suspend the electrical box 106 from the threaded rod 108.

To secure the support clip 110 to the threaded rod 108, the support clip 110 may include a thread impression 114 or other threaded feature may be formed on an upper surface of the clip body 112. As generally noted above, for example, the thread impression 114 may be configured to threadedly engage a threaded body (e.g., the threaded rod 108 shown in FIG. 3). In some examples, the illustrated configuration may allow attachment of the support clip 110 to the threaded rod 108 with relatively low torque (e.g., 25 in.-lbs. or less), further facilitating ease of installation.

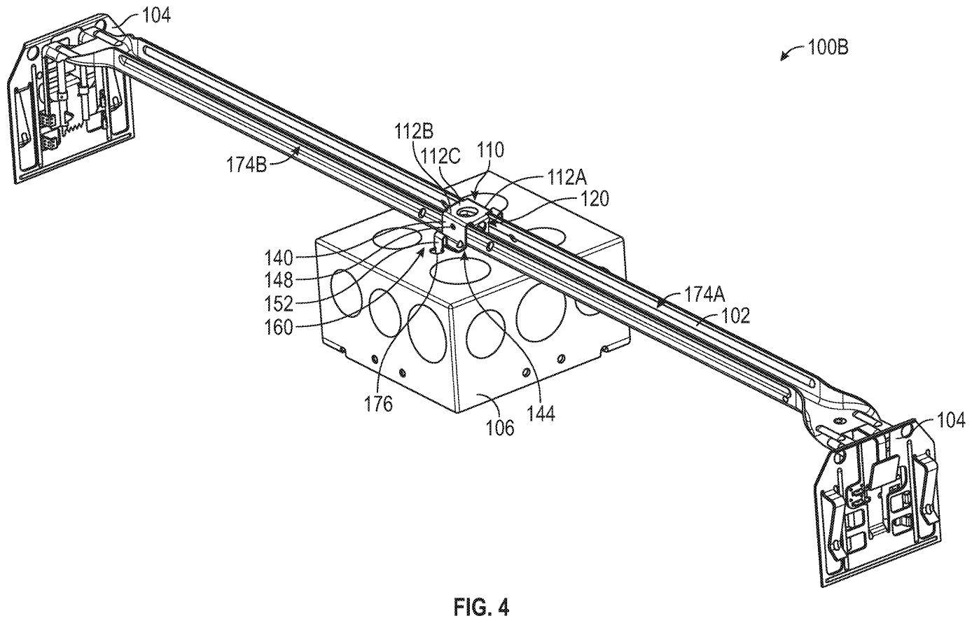

FIG. 4 illustrates an electrical assembly 100B according to another example of the disclosed technology. The electrical assembly 100B may include a support bar 102 and the electrical box 106 supported by the support bar 102. The support clip 110 according to an example of the disclosed technology may secure the electrical box 106 to the support bar 102.

In some cases, including as illustrated, the support bar 102 may be a cross bar or other rigid support of a ceiling assembly. For example, T-grid brackets 104 or other ceiling-installed brackets can be used to secure the support bar 102 at a particular location, for support of the electrical box 106 at a particular depth. Notably, the support clip 110 can be selectively installed in either of the configurations of FIGS. 3 and 4 to adaptably and securely suspend the electrical box 106 in either of the configurations of the electrical assembly 100A, 100B.

Generally, as further detailed below, the support clip 110 can resiliently engage with the electrical box 106 at mounting openings thereof, to secure the electrical box 106 to the support bar 102. Thus, in some examples, the support clip 110 can beneficially allow for manual (e.g., tool-free) and secure installation, including without requiring the use of separate fasteners or other loose parts in some configurations.

Returning to FIGS. 1 and 2, in particular, the locking arms 120 may extend integrally from the clip body 112. In some installations, the locking arms 120 can engage a support bar (e.g., the support bar 102 of FIG. 4) to help secure the support clip 110 against movement along the support bar, or can otherwise provide a biasing force that may help to urge catches of the support clip 110 into firm engagement with an electrical box.

The catch members 160 may also extend integrally from the clip body 112 (e.g., with the support clip 110 in general being integrally formed). In particular, the catch members 160 are shown extending transverse to the locking arms 120 (e.g., extending perpendicularly from the clip body 112, relative to the locking arms 120, from a top view perspective), although other orientations are possible. In some cases, the catch members 160 may extend from the first lateral side and the second lateral side of the clip body 112 (e.g., a first catch member extending from the first lateral side and a second catch member extending from the second lateral side). In particular, in the example shown, the catch members 160 may extend from the first lateral edge 112A and the second lateral edge 112B of the clip body 112. Thus, for example, the catch members 160 can generally flex relative to the clip body 112 to secure an electrical box thereto.

In some cases, the catch members 160 may be supported relative to the clip body 112 by an inner bend 170 and may include (or be supported by) an outer (or intermediate) bend 172 (e.g., both formed as return bends 170, 172, in this example). As shown, the inner return bend 170 is generally closer to the clip body 112 than the corresponding outer return bend 172, and bends in opposite directions relative to a common reference frame (e.g., a reference frame moving laterally outward from the clip body 112 along the relevant catch member 160).

In some examples, particular relative geometry of these bends 170, 172 can provide increased security of engagement with an electrical box under load, as further detailed below. For example, as shown in FIGS. 1 and 2, the inner return bends 170 may exhibit a wider profile than the outer return bends 172 relative to a lateral extension away from the clip body 112. Correspondingly, the outer return bends 172 can exhibit an effectively larger resistance to an un-bending deformation than do the inner return bends 170, for given application of force. As further detailed below, this characteristic can help to enhance engagement with an electrical box in some contexts. In some examples, gussets or other structures can be provided to further adjust the relative resistance to bending of the inner and outer return bends 170, 172 (e.g., as shown for the inner return bends 170 in FIGS. 1 and 2).

The catch members 160 may include free ends and may include catches 162 (e.g., integrally formed at the free ends) to secure the support clip 110 to a relevant component (e.g., an electrical box). The catches 162 may be formed as barbs or other hooked features, as shoulders, as tabs, as detents, or as other projecting retention features capable of engaging an interior surface of the electrical box 106. In particular, the catches 162 may extend laterally inwardly from the supporting catch member 160 (e.g., from the free end thereof) toward the clip body 112. For example, as shown, each of the catches 162 is formed as a barb with spaced apart blades that have angled edges 164 to extend laterally inwardly and upwardly toward the clip body 112. In other examples, however, other configurations are possible (e.g., with different numbers of barb blades or other geometries).

As illustrated in FIGS. 3 and 4, and further discussed below, the catches 162, may be configured to extend through mounting openings of the electrical box 106 to secure the electrical box 106 to the support clip 110. In some cases, the catches 162 at the free ends of the catch members 160 may engage with interior of the back wall of the electrical box 106 to secure the support clip 110. This engagement may occur when the catches 162 are received through the mounting openings of the electrical box 106. In some configurations, the catches 162 or other features on the catch members 160 can otherwise engage an electrical box (e.g., may engage the material of the electrical box within the relevant mounting openings). For example, the catch members 160 may include a shoulder 166 disposed above the catches 162. The shoulder 166 may exhibit a wider profile than a diameter of the corresponding mounting opening (e.g., a diameter of 0.25 or 0.215 inches) as well as a local width of the corresponding catch 162. The shoulder 166 may thus be configured to engage with a top surface of the electrical box 106 and to provide a stop against insertion of the free end of the corresponding catch member 160 into the corresponding mounting opening past a maximum insertion depth 168.

In some cases, the catch members 160 may include support arm portions 140 (e.g., generally, support arms 140) and catch arm portions 152 (e.g., generally, catch arms 152). The support arms 140 may support the catch members 160—and, in particular, the catch arm portions 152, relative to the clip body 112. In some cases, the support arms 140 may extend downwardly (e.g., vertically) from the corresponding first lateral side (e.g., extending from the edge 112A) or the second lateral side (e.g., extending from the edge 112B). In the example, shown, the support arms 140 may extend from the first lateral edge 112A or the second lateral edge 112B to the inner return bend 170. In some examples, the support arms 140 may extend to a support shelf 142 between the clip body 112 and the catch arms 152 (e.g., with the shelf 142 extending along the inner return bend 170, as shown). The support shelf 142 may include a seating surface 144 configured to seat on a wall (e.g., back wall) of the electrical box 106 when the corresponding catches 162 are received through the mounting openings to secure the electrical box 106 to the support clip 110. In other examples, however, such a seating surface may be differently located (e.g., not included on a corresponding catch member).

As mentioned above, the catch arms 152 may extend from the support arms 140. In some cases, the catch arms 152 may extend from the support arms 140 at the inner return bend 170. In particular, in the example shown, the catch arms 152 may extend from the support shelf 142. The catch arms 152 may extend generally downwardly, to be aligned to engage an electrical box during installation. In some cases, the catch arms 152 may extend upwardly (e.g., vertically) from the inner return bend 170 to the outer return bend 172 and then extend downwardly (e.g., vertically) to a free end. In other examples, the catch members 160 can extend from the support arms 140 (or the clip body 112) with different configurations. For example, a reference line 146 in FIGS. 1 and 2 indicates an example alternative location at which the catch members 160 can extend from the support arms 140, with corresponding potential changes to the relative location of the support shelf 142 (e.g., as may result in the support shelf 142 being removed, or at least not seating on the electrical box) and to the resilient response of the catch members 160 and the support clip 110 generally.

The support clip 110 can be formed to define a support channel 116 to help secure the support clip 110 to the support bar 102. The support channel 116 may generally be aligned between lateral sides of the support clip 110 and may extend between end openings on opposed ends of the support clip 110, along an axis configured to be aligned with an elongate direction of a support bar (e.g., the support bar 102) to receive the support bar into the support channel 116.

In the example of FIGS. 1 and 2, the end openings are further defined by openings 150, which are defined between the locking arms 120 and the clip body 112—in particular, between the locking arms 120 and the support arms 140. As further detailed below (and shown in FIG. 4), each of the openings 150 can thus receive a corresponding side wall of the support bar 102 to align the locking arms 120 within a channel of the support bar 102, with the support bar 102 extending through the support channel 116 of the support clip 110.

In different examples, different configurations of locking arms or other cantilevered features can be provided. In some cases, as shown, the locking arms 120 may include cut-outs 122 that may provide improved mechanical characteristics (e.g., resilient response, weight, etc.) or that may receive a drop wire for high-load installations. Further, in the example shown, the locking arms 120 include inner protrusions 124 and terminate at free engagement ends 126. The inner protrusions 124 on the locking arms 120 may be configured to engage with corresponding features of a support bar, providing additional security in the installed configuration (e.g., as further discussed below). The engagement ends 126 may be configured to resiliently engage a support structure (e.g., the support bar 102), to further enhance the secure attachment of the support clip 110 to the support bar 102. In particular, the engagement ends 126 may end with prongs 128 that terminate in end edges 130, which may provide a concentrated engagement force between the locking arms 120 and a support structure to prevent sliding of the support clip 110 (e.g., as further detailed below).

To facilitate anti-sliding engagement, the locking arms 120 may be configured to be resiliently flexed away from a rest configuration during installation (e.g., when aligned within a channel of a support bar, as shown in FIG. 4). In some cases, the locking arms 120 may correspondingly urge the support clip 110 in a direction opposite an insertion direction of the catch members 160 into the electrical box 106. In particular, the locking arms 120 may be resiliently movable relative to the clip body 112 from rest orientations to installation and installed orientations (e.g., corresponding to no loading of the locking arms 120, initial loading to install the support clip 110 onto a support bar, and final loading once the support clip 110 is engaged with an electrical box). This movement may allow the locking arms 120 to resiliently engage the support bar 102 within the channel as noted above, to appropriately secure the support clip 110 in place, including by inducing a responsive force at the catch members 160 to urge the catches 162 of the catch members 160 into the material of the interior side of a back wall of an electrical box.

Similarly to the locking arms 120, the catch members 160 may be resiliently movable relative to the clip body 112 from rest orientations to installation and installed orientations. In some examples, during installation, the catch members 160 may flex open by 10 to 20 degrees (e.g., to correspondingly open the 180-degree angle formed at the outer return bend 172). This flexibility may allow the catch members 160 to resiliently and easily engage the electrical box 106 at the mounting openings for manual installation. However, other configurations and modes of flexing are possible.

In some examples, outer protrusions 148 may be formed on the support clip 110 (e.g., on the support arms 140, as shown). As further detailed below, the outer protrusions 148 may provide additional—or alternative—points of engagement with a support bar to help secure the support clip 110 to the support bar (e.g., may be received into grooves or other recesses on the support bar 102). In some cases, including as shown, outer protrusions may be formed as stamped dimples or other integral features.

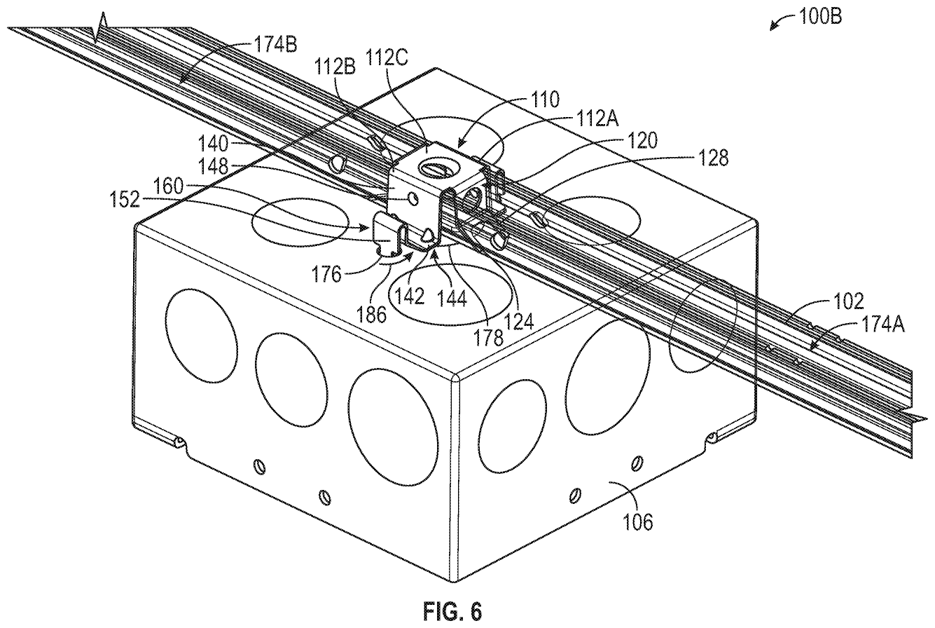

In some examples, further features can be provided. For example, tabs or other protrusions can be formed on the clip body 112 to further help in aligning the clip 110 with the support bar 102 or to help lock the clip 110 against unwanted sliding once installed. In some cases, such tabs or protrusions can be aligned to be received into a central channel of a support bar (e.g., of the support bar 102). For examples, alignment (or locking) tabs can be formed in some cases at cutouts 190 (shown in FIG. 6), or otherwise.

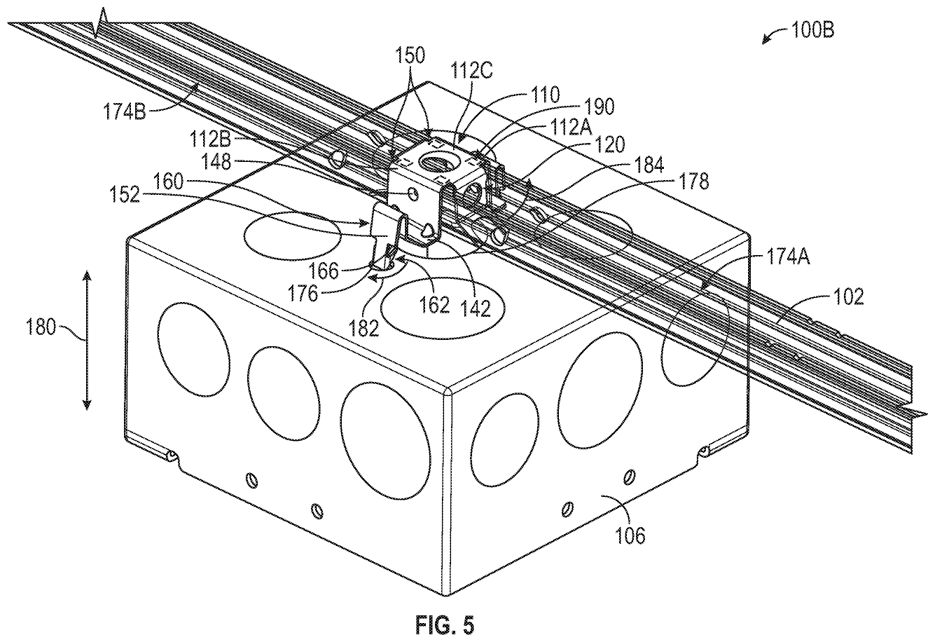

FIG. 5 illustrates the electrical assembly 100B during installation of the support clip 110 onto the support bar 102 to secure the electrical box 106. To initially install the support clip 110 onto the support bar 102, the support clip 110 may be aligned so that the openings 150 may receive side walls of the support bar 102. This configuration may align the locking arms 120 to extend into an inner channel 174A of the support bar 102, between the side walls. The inner protrusions 124 and outer protrusions 148 of the support clip 110 may correspondingly be moved (e.g., snapped) past top lips of the side walls of the support bar 102 to help secure the support clip 110 to the support bar 102. In some cases, the outer protrusions 148 may protrude into outer channels 174B (e.g., linear grooves) for sliding adjustment along the support bar 102, or the inner protrusions 124 may extend into corresponding inner channels (e.g., linear grooves) formed along the side walls within the (larger) channel 174A. In other examples, however, other engagement of a support bar may be possible (e.g., with alignment or locking tabs, as discussed above and below).

To install the electrical box 106, the catch members 160 may be initially aligned with mounting openings 176 in the electrical box 106. In the example illustrated, two mounting openings 176 are provided on a back wall of the electrical box 106, spaced 1.50 inches apart center-to-center and each with a diameter of 0.215 inches. In other examples, other spacings or otherwise varied configurations of one or more mounting openings may be possible (e.g., spaced 1.50 inches apart center-to-center, with a diameter of 0.25 inches). A corresponding clip with correspondingly modified spacing and orientation of one or more catch arms can be used with such arrangements as generally discussed herein. Generally, including as shown in FIG. 5, the catches 162 can be spaced so that tips of the catches 162 can be received into the corresponding mounting openings without deflection of the catch members 160, but also so that the catches 162 cannot pass fully through the mounting openings to secure the electrical box 106 without deformation of the catch members 160. In some examples, this resilient configuration can allow adaptable installation into a variety of box configurations (e.g., with 1.50 inch spacing and either 0.215 or 0.25 inches diameter).

Continuing, as the support clip 110 and the electrical box 106 are moved closer together along an installation direction (indicated by an arrow 180), the catch members 160 may resiliently deflect outwardly (indicated by an arrow 182) to allow the catches 162 to be received through the mounting openings 176 (e.g., may be deflected from a rest orientation to an installation orientation). In particular, the angled profile of the catches 162 can cause this movement to occur automatically, as the support clip 110 and the electrical box 106 are moved closer together. This movement may also further engage the locking arms 120 with the base wall of the inner channel 174A (e.g., urging the end edges 130 of the prongs 128 into the material of the base wall, for enhanced grip). After initial engagement, the locking arms 120 may correspondingly also be resiliently deflected (indicated by an arrow 184). For example, the locking arms 120 may be deflected from a rest orientation to an installation orientation, thus inducing a biasing force on the support clip 110 opposite the direction of insertion of the prongs 128 into the mounting openings 176 and correspondingly urging the catches 162 more firmly into the interior (underside) of the back wall of the electrical box 106.

FIG. 6 shows the completion of the installation process illustrated in FIG. 5. In particular, with further movement of the support clip 110 toward the electrical box 106 (or vice versa), the support clip 110 may be fully installed to secure the electrical box 106 for service. In some examples, this may correspond to the catches 162 being fully received through the mounting openings 176 and with the seating surfaces 144 being seated on the rear (or other corresponding) wall of the electrical box 106. Correspondingly, the catch members 160 may resiliently return from a maximum deflection (e.g., in the installation orientation) to an installed orientation (indicated by an arrow 186) to block removal of the catches 162 from the mounting openings 176 and thus retain the electrical box 106.

In the installed configuration, the catch members 160 may also be deflected outwardly relative to the rest orientation and the installation orientation. Correspondingly, and particularly in combination with the locking arms 120, the catch members 160 may continue to resiliently urge the support clip 110 away from the electrical box 106, via the support bar 102, to further enhance the security of the installation.

In some examples, the differing bend geometry of the inner return bends 170 and outer return bends 172 may also contribute to improved retention of an electrical box, particularly under load (e.g., vertical loading of the electrical box 106 by other supported electrical equipment (not shown)). As noted above, for example, the inner return bends 170 may exhibit a wider profile than the outer return bends 172. Correspondingly, with the support clip 110 installed as shown in FIG. 6, vertical loading on the electrical box 106 may tend to open the inner return bends 170 more easily than the outer return bends 172. As a result, the support clip 110 may tend to deform under loading to urge the catches 162 toward each other, rather than apart, and thus into more secure engagement with the electrical box 106 at the mounting openings 176.

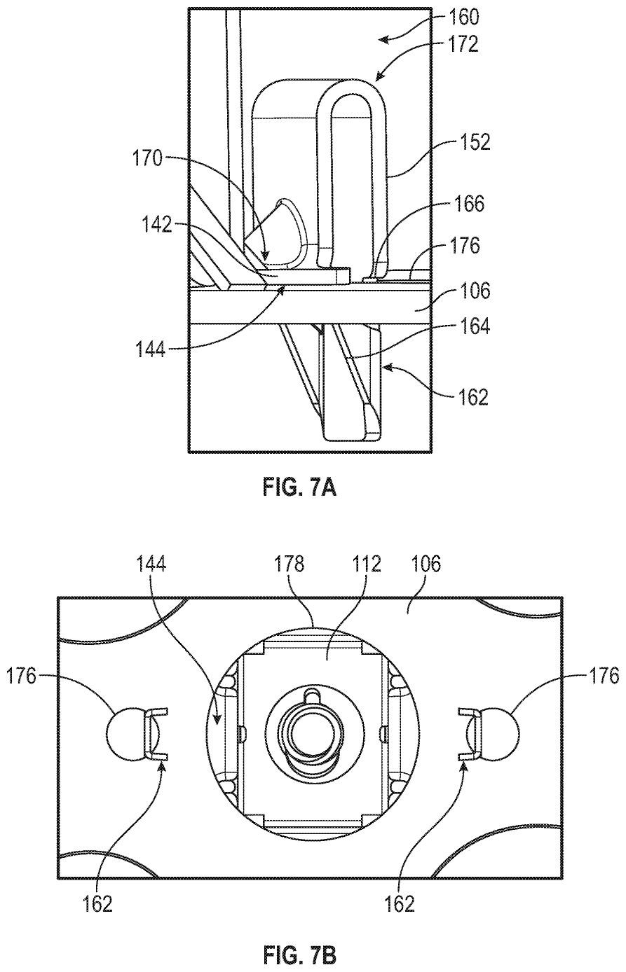

As shown in FIGS. 7A and 7B, the catches 162 may engage with an inner surface of the electrical box 106 adjacent to the corresponding mounting openings 176, while the seating surface 144 may provide stable contact against the outer box surface. Thus, the rear wall of the electrical box 106 can be securely captured between the seating surface 144 and the catches 162, for a highly secure mounting arrangement between the electrical box 106 and the clip 110. Still further, in some examples (as also noted above), resilient response of the support clip 110 overall may tend to urge the catches 162 firmly into the material of the inner surface of the electrical box 106 (e.g., via resilient response of the locking arms 120.

As also shown in FIG. 7B, in some cases, the seating surfaces 144 may extend wider than a knockout 178 on the electrical box 106. This configuration may allow the seating surface 144 to firmly and securely contact the electrical box 106 (as also discussed above), further enhancing the security of connection for the assembly overall. In other examples, seating surfaces can be otherwise configured to avoid passing through the knockout 178 (e.g., can be laterally spaced on opposing sides of the catches 162, as discussed below).

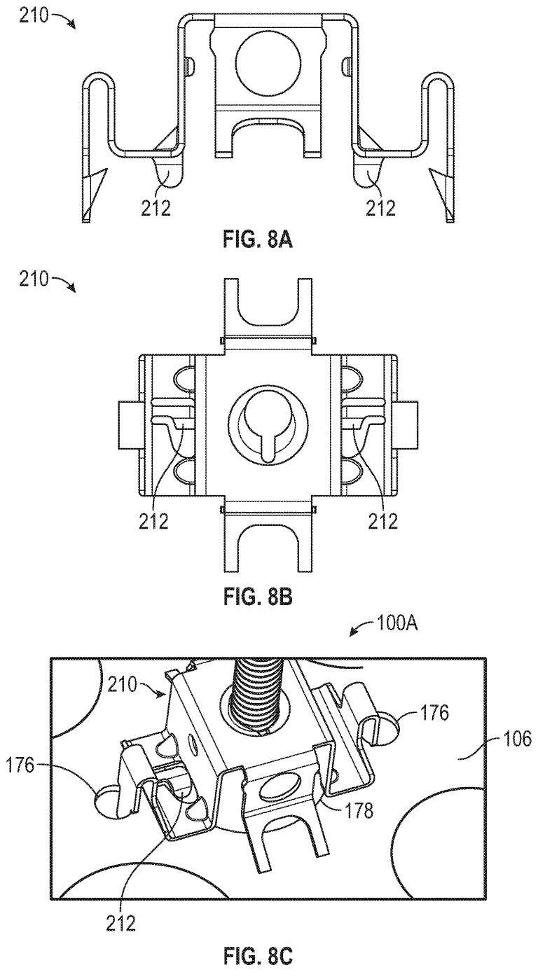

FIG. 8A through FIG. 8C illustrate an alternative configuration of a support clip 210. The support clip 210 is similar in construction to the support clip 110 described previously, and discussion of the support clip 110 above thus also applies to the support clip 210 unless otherwise indicated.

However, in some respects, the support clip 210 differs from the support clip 110. For example, the support clip 210 may include alignment tabs 212 that extend from the seating surfaces (or otherwise) toward an attached electrical box.

As shown in FIG. 8C, in particular, the alignment tabs 212 may extend into the knockout 178 of the electrical box 106. For example, the alignment tabs 212 may be spaced apart so as to engage with edges of the knockout 178 (e.g., at opposed sides of the perimeter thereof). Thus, the alignment tabs 212 may be configured to engage with material of the electrical box 106 (e.g., at a knockout 178) to block movement of support clip 210 in opposed directions, with corresponding improvements in the ease and security of the installation overall.

Engagement of the electrical box 106 by the alignment tabs 212 may also help to appropriately align the support clip 210 for engagement of the catch members 160 with the mounting openings 176 of the electrical box 106. For example, as shown in FIG. 8C, the alignment tabs 212 may be designed to ramp into place along the edge of the knockout 178 as the support clip 210 is installed onto the electrical box 106. This configuration may both smooth the insertion of the alignment tabs 212 into the knockout 178 during installation and help to align the catch arms of the support clip 210 with the mounting openings 176.

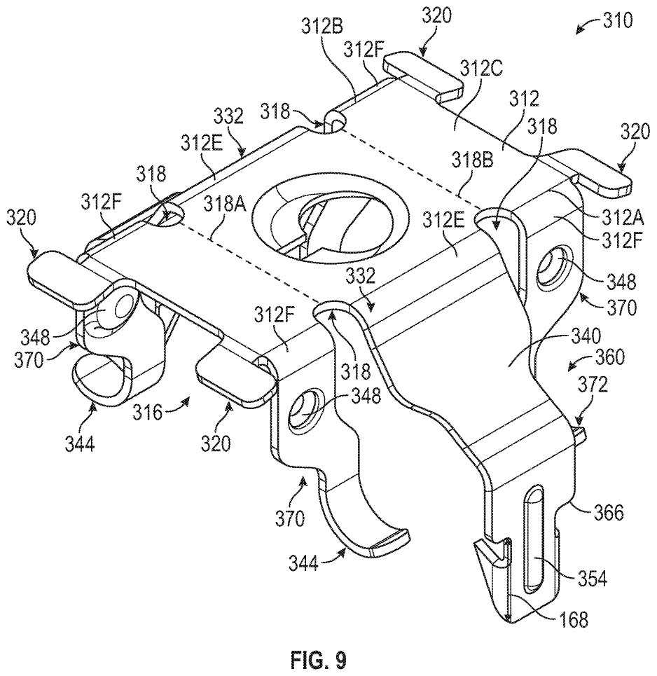

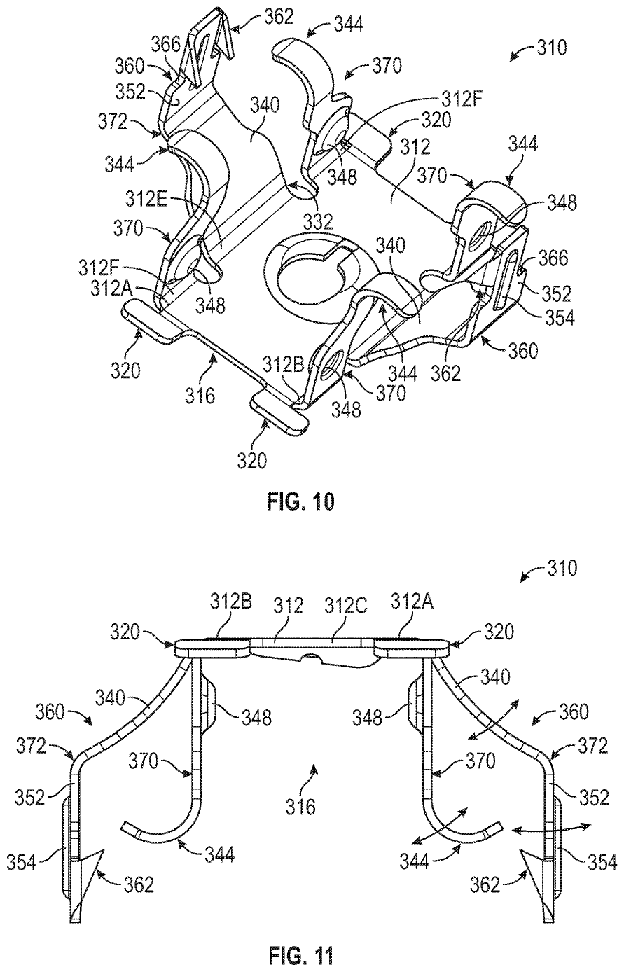

FIGS. 9 and 10 illustrate isometric views of another alternative configuration of a support clip 310. The support clip 310 is similar in construction to the support clip 110 described previously, and discussion above thus applies to the support clip 310 unless otherwise indicated, particularly relative to similarly named features. For example, the support clip 310 may include a clip body 312 that is generally similar to the clip body 112, and catch members 360 that are generally similar to the catch members 160, with certain differences discussed below. Accordingly, unless otherwise indicated, discussion of these features of the support clip 110 may also apply to the corresponding features of the support clip 310.

In the illustrated example of the support clip 310, the catch members 360 may extend integrally from a catch-member portion 312E of the clip body 312. For example, as shown, the catch members 360 extend from a central portion of respective lateral sides of the clip body 312 (e.g., extend integrally from bends 332 at the lateral edges 312A, 312B). In some cases, the catch members 360 may extend laterally outwardly and downwardly from the corresponding portion of the clip body 312. For example, the catch members 360 may extend laterally outwardly and downwardly (relative to a top side 312C) from the lateral edges 312A, 312B to allow easy and secure manual installation, as further detailed below.

In particular, in the illustrated example, the catch members 360 include support arm portions 340 (e.g., generally, support arms 340) and catch arm portions 352 (e.g., generally, catch arms 352). Thus, for example, the support arms 340 can support the catch arms 352 relative to the clip body 312 similarly to the support arms 140 and the catch arms 152. As shown, for example, the support arms 340 may be integral with the clip body 312, extending from corresponding lateral sides of the clip body 312. In particular, the support arms 340 may extend from the corresponding lateral edge 312A, 312B, at a corresponding bend to angle downwardly from the clip body 312 toward the corresponding catch arm 352 (e.g., at a rest angle in a range of about 50 degrees to about 70 degrees below horizontal).

In some cases, the support arms 340 may extend from the bends 332 at the clip body 312 to intermediate bends 372, and the catch arms 352 may extend downwardly from the support arms 340 at the intermediate bends 372. Thus, for example, the catch members 360 overall may include a non-linear profile, including at least one bend between the clip body 312 and the free ends of the catch arms 352. As shown, for example, the catch arms 352 may extend at a rest angle with a range of about 110 degrees to about 130 degrees relative to the support arms 340 (e.g., to extend substantially vertically from the bends 372), although other configurations are possible.

As similarly discussed above, the free end of the catch arms 352 may include catches 362, which may be formed as barbs or in other forms, as also discussed above. Thus, generally, the catch arms 352 can flex relative to the support arms 340 (e.g., at the bends 372) and the support arms 340 can flex relative to the clip body 312 (e.g., at the edges 312A, 312B) to allow the catches 362 to pass through an opening in a wall of an electrical box and then be resiliently returned into engagement with the interior surface of the wall.

In some examples, features on a catch member can contribute to variation in resilient response and corresponding adjustment of bending profiles of the catch member. For example, in some cases, the catch arms 352 may further include a rib 354 (e.g., as an embossed or otherwise integrally formed feature). In particular, the rib 354 may extend between the intermediate bend 372 and the free end of the catch arm 352 (e.g., including along the corresponding catch 362). Generally, the rib 354 can help to strengthen the catch arm 352 against local deformation, to which the catch arm 352 may be otherwise more susceptible due to the relatively narrow width of material that is required to allow passage through electrical box openings (e.g., so that bending is localized to primarily to the bends 332, 372). Further, this general strengthening of the catch arm 352 can also help to divert deformation of the catch member 360 to desired locations (e.g., to the bends 332, 372 generally, as illustrated by bending movements shown in FIG. 11).

In the illustrated example, the rib 354 is provided on the catch arms 352 but is not provided on the support arms 340. As illustrated in FIG. 11, this configuration may allow for a difference in bending stiffness between the catch arms 352 and the support arms 340. In particular, the support arms 340 may generally exhibit greater bending for a given input force, while the catch arms 352 may generally exhibit less. This configuration may be beneficial during installation, by permitting the catch members 360 overall to flex sufficiently for insertion, and in the installed configuration, by resisting deformation that might result in withdrawal of the catches 362 from the electrical box 106. For example, during installation, the support arms 340 may flex laterally outwardly at the bends 332 from an angle of about 60 degrees below horizontal to an angle of about 45 degrees below horizontal, while the catch members 360 may move via flexing of the bends 372 from about 120 degrees to about 135 degrees. The catch members 360 can then return via a resilient unflexing of the bends 372 back toward—or to—about 120 degrees (e.g., with the bends 332 also returning toward—or to—about 60 degrees). Further, for example, during loading from engagement with an electrical box 106, the enhanced stiffness of the catch arms 352 may generally resist deformation and maintain a beneficial orientation of the catches 362, while the support arms 340 may exhibit more flexibility, both to allow easy insertion of the catches 362 through corresponding mounting openings and to improve overall resilient response to in-service loading.

As noted above, in some examples, the support clip 310 may include spring arms 370 (e.g., integrally formed with the clip body 312). In the illustrated example, the spring arms 370 are symmetrical relative to each other. Accordingly, description herein of one of the spring arms 370 generally applies to the other spring arms 370. In other examples, however, other configurations are possible (e.g., with different numbers or differently arranged spring arms). Generally, as further detailed below, the spring arms 370 can engage with a box wall to provide biasing force during and after installation, thus providing biasing engagement similar to the locking arms 120, albeit by engaging different structures (e.g., a box wall rather than a support bar).

In the illustrated example, the support clip 310 includes four spring arms 370 that extend from spring-arm portions 312F of the clip body 312. In particular, the spring-arm portions 312F may be along the lateral sides of the clip body 312 (e.g., with the spring arms 370 extending from the lateral edges 312A, 312B). In some cases, a set of the spring arms 370 may extend from the same lateral edge 312A, 312B as a corresponding one of the catch members 360. Further, sets of the spring arms 370 may be located on opposing sides of a corresponding catch member 360, so that the catch member 360 is between at least two of the spring arms 370 along a particular side of the clip body 312. Thus, for example, resilient force from the spring arms 370 during installation can be applied with balance across each of the catch members 360. However other configurations are possible.

Generally, to provide response force upon installation and thereby help to secure the catch members 360 in place, the spring arms 370 may include seating surfaces 344 that are resiliently supported relative to the clip body 312. Generally, similarly to the seating surfaces 144 (and to the prongs 128) of the support clip 110, the seating surfaces can bear against an electrical box in some installations, to help secure catches against the interior side of a wall of an electrical box. In the illustrated example, the seating surfaces 344 are downwardly-facing so as to be oriented to engage an outer surface of a wall (e.g., rear wall) of an electrical box through which the catch members 360 extend. In particular, to avoid undue interference with features on an electrical box (e.g., knock-out openings), the seating surface 344 may be supported by the spring arms 370 with the surfaces 344 positioned laterally inwardly from the catches 362, between the clip body 312 and the catches 362. Correspondingly, the spring arms 370 may extend laterally outwardly and downwardly from the clip body 312 to the seating surfaces 344 (e.g., with multiple spring arms 370 extending downwardly from each of the lateral edges 312A, 312B).

In some examples, the spring arms 370 generally—and the seating surface 344, in particular—may include a curved profile to allow smoother engagement with and movement along an electrical box. For example, as shown, the seating surfaces 344 curve upwardly toward free ends of the spring arms 370 and laterally away from the clip body 312. Correspondingly, when in an installed configuration, the curved profile may define a radius of curvature such that the seating surfaces 344 bends upwardly, away from the electrical box 106, and thus avoids digging into or otherwise catching on the electrical box (e.g., the electrical box 106). In other words, the seating surface 344 may be aligned to seat on the wall (e.g., exterior side of the back wall) of the electrical box 106 when the corresponding catches 362 engage the wall (e.g., interior side of the back wall) of the electrical box 106, and to also curve away from the wall in some examples.

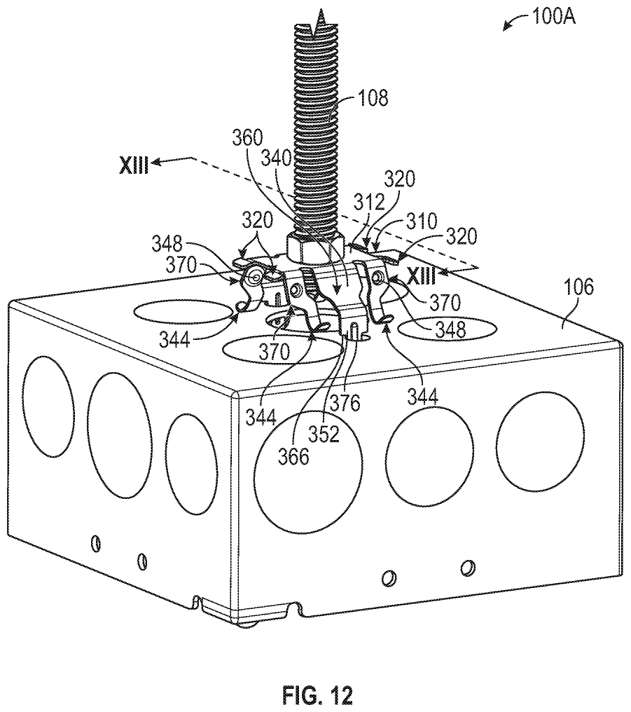

Thus, in general, the seating surfaces 344 can be aligned to resiliently engage the spring arms 370 with the wall (e.g., exterior side of the back wall) of the electrical box 106 and thus provide a biasing force on the clip body 312 upwardly away from the electrical box 106 and a corresponding induced force that urges the catches 362 into the interior side of the electrical box 106. Further, as shown in FIG. 12 for example, the seating surfaces 344 may be oriented to engage the wall (e.g., the exterior side of the back wall) of the electrical box 106 at locations that laterally inward from the catches 362 (e.g., between the catches and the clip body) and correspondingly aligned to avoid the larger knock-outs on the wall.

In some cases, the support clip 310 may define relief regions 318 formed in the clip body 312. For example, the relief regions 318 may be provided on the top side 312C of the clip body 312. In the illustrated example, in particular, the relief regions 318 are defined between the spring-arm portions 312F and the catch-member portion 312E, which may allow easier flexing of the clip body 312 between those portions 312E, 312F, as further discussed below.

In general, the relief regions 318 may be configured as weakened regions of the clip body 312, to help preferentially localize and orient bending in response to external forces. For example, although the relief regions 318 are shown as sets of aligned cut-offs that define corresponding flex lines 318A, 318B, other configurations can include other structures or geometries to otherwise provide reduced cross-section, reduced width, reduced material thickness, or other configurations capable of locally reducing bending stiffness (e.g., stamped depressions, score lines, slots, apertures, or other structures).

In the illustrated example, the flex lines 318A, 318B extend between the first lateral edge 312A and the second lateral edge 312B, generally in parallel with the lateral direction. Accordingly, the flex lines 318A, 318B may allow for the spring-arm portions 312F of the clip body 312 to flex upwardly relative to the catch-member portion 312E, while limiting corresponding other movement (e.g., deformation) of other portions of the clip body 312. Thus, for example, the flex lines 318A, 318B may allow for the spring arms 370 to flex upwardly as the catches 362 are extended into engagement with a box wall, which may beneficially help to accommodate variations in box wall thickness between different boxes, without introducing adverse deformation of the clip body 312 or loss of hold strength.

Similarly to the support clip 110, the support clip 310 may define a support channel 316 that can receive a support bar in some installations. For example, as shown, the clip body 312 defines the support channel 316 in combination with the spring arms 370 and the catch members 360, similarly to the clip body 112 and the catch members 160. As further discussed below, the support channel 316 may be configured to receive the support bar 102 to secure a support clip 310 for support of an electrical box.

In some cases, the support clip 310 may include additional features to further engage with the support bar 102. For example, the spring arms 370 (or other features) may include protrusions 348 that extend laterally inwardly. Thus, for example, the protrusions 348 may be configured to engage the support bar 102 within the support channel 316 similarly to the protrusions 148.

In some cases, locking arms may be configured as locking tabs that also extend to biasingly engage a support bar received within the support channel 316. For example, locking members configured as locking tabs 320 may extend integrally from opposite ends of the clip body 312 (e.g., from sides of the clip body 312 that are different from the lateral sides that include the edges 312A, 312B). In particular, as shown, the locking tabs 320 may extend as cantilevered features from the spring-arm portions 312F of the clip body 312. Accordingly, for example, the locking tabs 320 can move generally with the spring arms 370 while also themselves acting to preferentially flex the spring-arm portions 312F of the clip when under loading (e.g., to avoid loss of hold at the catches 362). In some cases, the locking tabs 320 may be cantilevered to angle downwardly relative to the clip body 312. In particular, for example, the locking tabs 320 may angle downwardly to overlap vertically with the support channel 316. Accordingly, as further discussed below, the locking tabs 320 may be configured to resiliently engage with the support bar 102 when the support bar is received into the support channel 316.

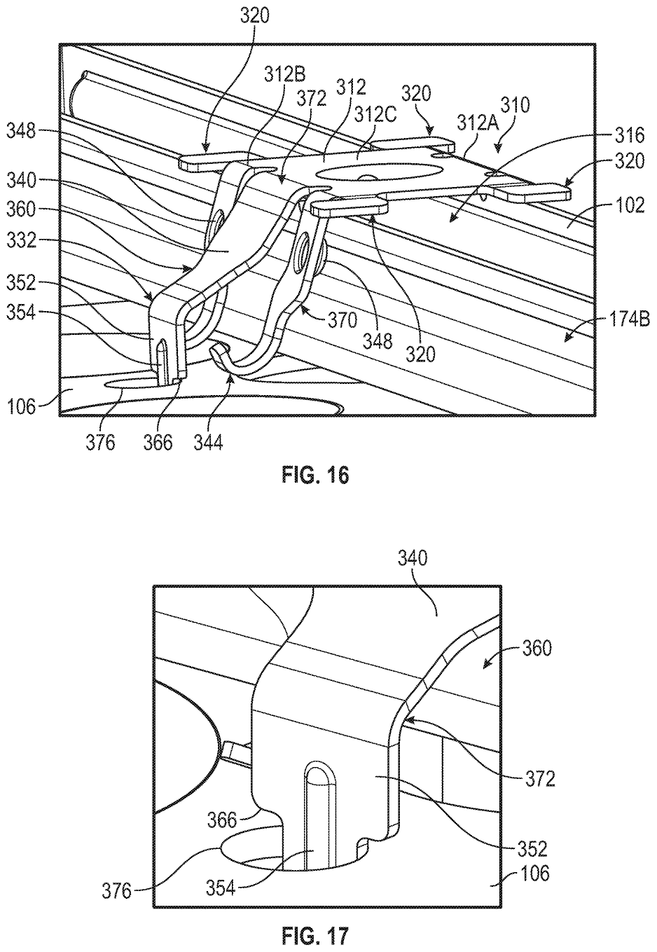

As also generally discussed above, the support clip 310 may be resiliently movable from rest orientations to installed orientations. As illustrated in FIG. 11, the catch members 360 and the spring arms 370 may be resiliently movable relative to the clip body 312, in particularly with outward deflections and resilient return, as indicated by double-headed arrows. Correspondingly, the catches 362 and the seating surfaces 344 of the spring arms 370 can be resiliently deflected to move laterally outwardly (e.g., by contact with an electrical box during installation). Thus, as similarly discussed above, the catch members 360 can readily flex for insertion through mounting openings in a box wall (e.g., mounting openings 376, as shown in FIGS. 12-17). Further, shoulders 366 on the catch members 360 can help to guard against over-insertion, similarly to the shoulders 166.

As also discussed above, the support arms 340 and the catch arms 352 may exhibit different structural resilience, resulting in different degrees of bending at different parts of the catch members 360 overall. In particular, the support arms 340 may be relatively more flexible, while the catch arms 352 may be relatively stiffer (e.g., due in part to the presence of the rib 354 on the catch arms 352). This difference in stiffness may allow the catch members 360 to deflect sufficiently to allow easy installation while also helping to maintain the orientation and engagement of the catches 362 in the installed configuration, even under significant loading. For example, upon vertically downward loading by an attached electrical box, the support arms 340 may deflect primarily downwardly due to the downward and outwardly oriented profile of those portions of the catch members 360, whereas the catch arms 352 may deflect relatively little overall—particularly relative to a laterally outward direction—to help maintain secure engagement of the electrical box (e.g., with the catch arms 352 remain substantially vertical). In some cases, the illustrated configuration or other similar configurations may tend even to urge the catch arms 352 laterally towards each other upon vertical loading, thereby enhancing the hold of the laterally-inward catches 362 on the box.

In other words, in some cases the support arms 340 can be configured to exhibit a lower bending stiffness than the catch arms 352 relative to expected loading (e.g., vertical loading on the electrical box 106) so that such loading causes the support arms 340 to deflect preferentially (e.g., and thereby guide deflected movement of the catch arms 352). In this regard, for example, because the support arms 340 angle laterally outwardly and downwardly from the clip body 312 in the example shown, downward deflection of the support arms 340 under vertical loading can create a lever-arm movement that urges the catch arms 352 laterally inwardly toward each other. This inward movement of the catch arms 352 can correspondingly urge the catches 362 more firmly into the interior side of the back wall of the electrical box 106, thereby further resisting pull-out of the catches 362 and correspondingly enhancing the security of the connection under load.

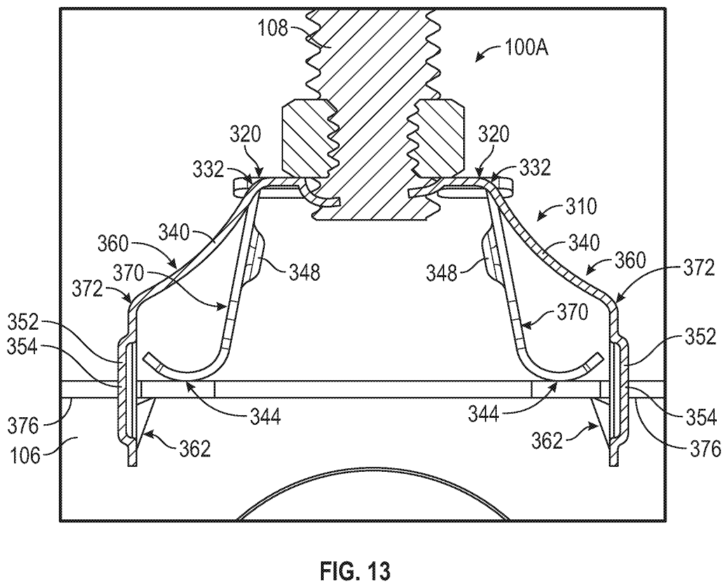

As illustrated in FIGS. 12-13, some configurations of the electrical assembly 100A may include the support clip 310 secured to the threaded rod 108, to suspend the electrical box 106 from the threaded rod 108. As generally discussed above, the catch members 360 may extend through corresponding mounting openings in the back wall of the electrical box 106, with the catches 362 engaging an interior side of the back wall of the electrical box 106. The spring arms 370 may simultaneously engage the exterior side of the back wall of the electrical box 106, with the seating surfaces 344 seating against the exterior surface of the back wall of the electrical box 106. Engagement of the seating surfaces 344 may bias the spring arms 370 to urge the electrical box 106 away from the clip body 312, thereby placing the catch members 360 in tension and more securely engaging the catches 362 with the interior side of the back wall of the electrical box 106. Thus, the spring arms 370 may further provide stability for the support clip 310 relative to the electrical box 106.

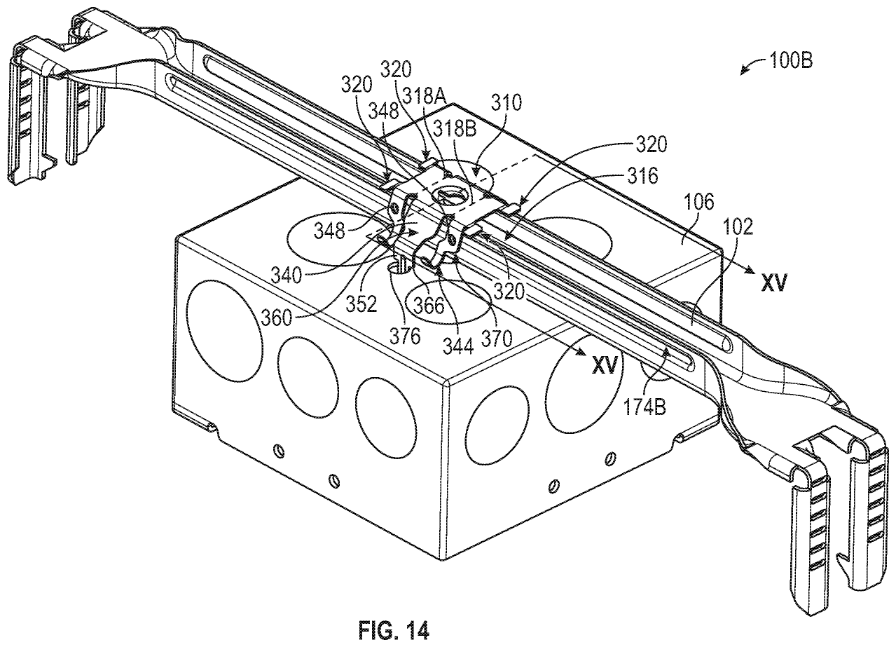

As shown in FIGS. 14-16, some configurations of the electrical assembly 100B may include the support clip 310 to secure the electrical box 106 to the support bar 102. As discussed above, the support channel 316 can receive the support bar 102 to support the support clip 310 relative to gravity, while the catches 362 support the electrical box 106 relative to the support clip 310. As also mentioned above, the spring arms 370 and catch members 360 may correspondingly be deflected outwardly during installation. For example, the spring arms 370 may deflect outwardly to accommodate the support bar 102 as well as to provide a change in vertical spacing between the clip body 312 and the seating surfaces 344. For example, the spring arms 370 may flex outwardly during installation from substantially vertical (or about 90 degrees relative to the clip body 312) to an angle of about 15 degrees from vertical (or about 105 degrees relative to the clip body 312), and then, once installed, resiliently return toward substantially vertical (or about 90 degrees relative to the clip body 312). Thus, the flexing of the spring arms 370 (e.g., by up to about 15 degrees, or more) may allow corresponding changes in vertical spacing between the clip body 312 and the electrical box 106, as may be necessary to insert the catches 362 into engagement with the electrical box, while also providing a resilient response force to firmly engage the catches 362 with the interior surface of the box wall.

As mentioned above, the spring arms 370 may include the protrusions 348. In particular, the protrusions 348 may be positioned to align with the outer channel 174B defined by the support bar 102, so that the protrusions 348 are received into the outer channel 174B when the support clip 310 is installed onto the support bar 102. This engagement can help to secure the support clip 310 against removal from the support bar 102 while also helping to resist unwanted sliding of the support clip 310 along the support bar 102. In some cases, when the spring arms 370 are engaged with the electrical box 106, the spring arms 370 may correspondingly urge the protrusion 348 into the top of the outer channel 174B to further inhibit sliding of the support bar 102 within the support channel 316. Thus, for example, the support clip 310 may be more easily slid along the support bar 102 to provide alignment for installation of the box, then less easily slid along the support bar 102 after the box is secured thereto.

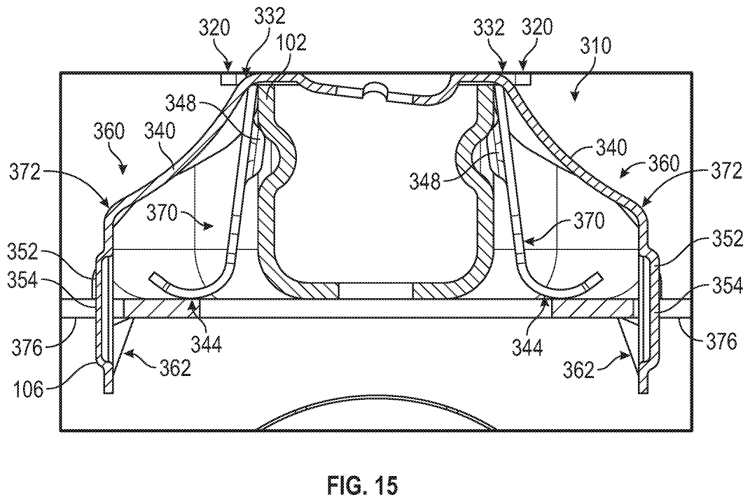

As shown in FIG. 15, in some installations, engagement of the protrusions 348 with the support bar 102 may result in some flexure of the spring arms 370 away from a rest orientation (e.g., a 90-degree extension away from the clip body 312). In other examples, the protrusions 348 may nest fully into the outer channels 174B. In such a case, for example, the spring arms 370 may exhibit additional flexing closer to the seating surface 344 than to the clip body 312, to resiliently provide a response force on the electrical box 106.

In some cases, the locking tabs 320 may resiliently engage the support bar 102. For example, as discussed above, the locking tabs 320 may overlap with the support channel 316 and thus resiliently engage the support bar 102 when the support bar 102 is received into the support channel 316. This resilient engagement by the locking tabs 320 may help to prevent the support clip 310 from sliding along the support bar 102 (e.g., in combination with the engagement by the protrusions 348, as discussed above). In particular, the downward angle of the locking tabs 320 may orient the locking tabs 320 to resiliently engage with the top surfaces of the support bar 102. Correspondingly, the locking tabs 320 may biasingly urge the clip body 312 upwardly away from the support bar 102 and thus also help to urge the catches 362 more firmly into the interior surface of the box wall.

Also as mentioned above, the clip body 312 may include relief regions 318, which may allow for deformation of the clip body 312 during installation. For example, for electrical boxes with thicker walls, the support clip 310 may have to deform somewhat over the support bar 102 to allow the catches 362 to pass into the electrical box 106 for securing engagement. The relief region 318 may allow for the catch members 360 to move downwardly to engage the catches with the interior back wall of the electrical box 106 somewhat independently from the spring arms 370 and the locking tabs 320, which may correspondingly tend to move relatively upwardly. As a result, the clip body 312 may flex in a controlled manner to accommodate different box wall thicknesses, without adverse impact on the resilient engagement of the catches 362 with the electrical box (e.g., as enhanced by resilient response forces from the spring arms 370 and the locking tabs 320). In some implementations, similar features can also be provided on the support clip 110.

In some implementations, devices or systems disclosed herein can be utilized, manufactured, installed, etc. using methods embodying aspects of the disclosed technology. Correspondingly, unless otherwise indicated, any description herein of particular features, capabilities, or intended purposes of a device or system should be considered to disclose, as examples of the disclosed technology a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated, discussion herein of any method of manufacturing or using for a particular device or system, including installing the device or system, should be understood to disclose, as examples of the disclosed technology, the utilized features and implemented capabilities of such device or system.

In this regard, the disclosed technology can be installed according to various methods, as further detailed above and below. In some examples, as illustrated in FIGS. 1 and 2, users may selectively employ either a support bar or a threaded rod based on their specific installation requirements.

For support bar mounting, as shown in FIG. 1, installation may begin by aligning the support clip with a support bar. In an installation orientation, the support clip may thus be positioned to receive the side walls of the support bar, so that locking arms of the support clip extend into an inner channel of the support bar. In some cases, staging a support clip on a support bar may correspondingly flex the locking arms to an installation orientation, in which the locking arms are flexed by the support bar away from a rest orientation.

With the support clip attached to the support bar, the support clip may be effectively staged for installation, but may still be movable with sufficient engagement by a user (e.g., may be manually movable to be slid to appropriate alignment along the support bar). With the support clip appropriately positioned, catch arms of the support clip may be aligned with the corresponding electrical box. In particular, the catch arms of the support clip may be positioned to correspond with mounting openings on the electrical box (or vice versa).

The support clip and the electrical box can then be moved together (e.g., by moving the electrical box toward the support clip), to decrease the distance therebetween along an insertion direction. This movement may cause the catch arms to deflect outwardly, allowing the catch arms to be received through the mounting openings of the electrical box. As ends of the catch arms pass through the mounting openings, the catch arms overall may resiliently return toward their original position, thus securing the electrical box to the support clip. Further, the locking arms may simultaneously be flexed to an installed orientation, via engagement of the electrical box with the catches and corresponding forces on the support clip, to resiliently bear against the support bar and thus further secure the support clip and the electrical box.

For threaded rod mounting, including as shown in FIG. 2, a similar process may be employed. However, the support clip can be secured to the threaded rod via a thread impression or other threaded feature, rather than secured to a support bar as described above. Correspondingly, there may be no deflection of the locking arms, because of the absence of a support bar to bear against. Once the support clip is installed on the threaded rod, the electrical box can then be attached to the support clip as discussed above—again, however, without necessarily deflecting the locking arms.

With flexibility for installation in both mounting configurations, example support clips according to the disclosed technology may reliably and conveniently secure an electrical box in a variety of installations. In particular, the resilient configuration of catch arms (e.g., and of locking arms) may allow for tool-free installation while providing a reliably secure connection. Indeed, in some cases, support clips as illustrated herein may be capable of holding a load of up to 50 lbs. (or more).

More specifically, in some examples, a method of installing an electrical box can include providing a support clip having a clip body with catch members and spring arms extending therefrom. The catch members can include catches at free ends thereof, and the spring arms can include downwardly-facing seating surfaces. The method can include aligning the support clip with mounting openings of the electrical box. In particular, the catches of the catch members can be positioned to correspond with the mounting openings on a back wall of the electrical box (e.g., as shown in FIG. 5 for support clip 110, or with similar alignment of the support clip 310).

With the support clip aligned, the method can include decreasing a distance between the support clip and the electrical box along an insertion direction. This movement can resiliently move the catch members from rest orientations toward installation orientations. In particular, as the catches contact edges of the mounting openings, the catch members can deflect laterally outwardly to allow the catches to pass through the mounting openings. As the catches clear the mounting openings, the catch members can resiliently return toward their rest orientations, thereby engaging the catches with an interior side of the back wall of the electrical box.

Simultaneously with or subsequent to engagement of the catches, the seating surfaces of the spring arms can be seated on an exterior side of the back wall of the electrical box (e.g., by the same relative movement of the support clip that deflects the catch members toward the installation orientations). This seating can resiliently deflect the spring arms, which can correspondingly urge the catches into (firmer) engagement with the interior side of the back wall. Thus, the resilient response of the spring arms can provide a biasing force that enhances the security of the connection between the support clip and the electrical box.

In some configurations, the method can further include securing the support clip to a support bar before attaching the electrical box. For example, the support clip can define a support channel configured to receive the support bar (e.g., as shown in FIGS. 5-6 and 14-16). In some cases, the support clip can include locking tabs that extend downwardly so as to be aligned to engage an upward facing (e.g., top) surface of the support bar. When the support bar is received into the support channel and the catches are engaged with the electrical box, the locking tabs can resiliently engage the support bar to biasingly urge the clip body upwardly away from the support bar. This biasing force can further urge the catches into the interior side of the back wall of the electrical box, enhancing the overall security of the installation.

In other configurations, the method can include securing the support clip to a threaded rod before (or after) attaching the electrical box. For example, the clip body can include a thread impression configured to receive the threaded rod (e.g., as shown in FIGS. 3 and 12-13). The support clip can be threaded onto the threaded rod to suspend the support clip at a desired location. The electrical box can then be attached to the support clip by decreasing the distance between the support clip and the electrical box as discussed above.

Thus, in general, methods according to the disclosed technology can provide efficient installation of electrical boxes using the resilient engagement of catch members and spring arms. The simultaneous or sequential engagement of the catches with the interior side of the back wall and the seating surfaces with the exterior side of the back wall can provide a secure, tool-free connection. Further, the optional use of support bar or threaded rod mounting can provide additional versatility and security for various installation configurations.

Thus, embodiments of the invention can provide improved support devices for electrical boxes or other electrical components. In some embodiments, for example, improved support clips and related systems and methods for supporting electrical boxes may not require loose hardware, such as fasteners, to secure electrical boxes in installed orientations. Further, the disclosed design can be readily adapted to a wide range of box configurations. Therefore, installation and adjustments may be substantially simplified as compared to conventional designs.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order. Relatedly, similar or identical components may be referred to with different ordinal numbers in different contexts.

Also as used herein, unless otherwise specified or limited, directional terms are presented only with regard to the particular embodiment and perspective described. For example, reference to features or directions as “horizontal,” “vertical,” “front,” “rear,” “left,” “right,” and so on are generally made with reference to a particular figure or example and are not necessarily indicative of an absolute orientation or direction. However, relative directional terms for a particular embodiment may generally apply to alternative orientations of that embodiment. For example, “front” and “rear” directions or features (or “right” and “left” directions or features, and so on) may be generally understood to indicate relatively opposite directions or features.

As used herein in the context of activities or engagement of components, unless otherwise specified or limited, “manual” refers to the use of human hands. In some cases, “manual” engagement or activity can include direct manual engagement or activity: i.e., engagement or activity directly conducted by a user's hands (e.g., a user grasping or manipulating an object by hand). In some cases, “manual” engagement or activity can include engagement or activity via a non-powered hand tool (e.g., pliers).

Also as used herein, unless otherwise specified or limited, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either of”, “only one of,” or “a single one of.” For example, a list of “only one of A, B, or C” indicates options of: A, but not B and C; B, but not A and C; and C, but not A and B. In contrast, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more A, one or more B, and one or more C. Similarly, a list preceded by “a plurality of” (and variations thereon) and including “or” to separate listed elements indicates options of one or more of each of multiple of the listed elements. For example, the phrases “a plurality of A, B, or C” and “two or more of A, B, or C” indicate options of: one or more A and one or more B; one or more B and one or more C; one or more A and one or more C; and one or more A, one or more B, and one or more C.

Also as used herein, unless otherwise specified or limited, “integral” and derivatives thereof (e.g., “integrally”) describe elements that are manufactured as a single piece without fasteners, adhesive, or the like to secure separate components together. For example, an element that is stamped, cast, or otherwise molded as a single-piece component from a single piece of sheet metal or other continuous single piece of material, without rivets, screws, other fasteners, or adhesive to hold separately formed pieces together, is an integral (and integrally formed) element. In contrast, an element formed from multiple pieces that are separately formed initially then later fastened together, is not an integral (or integrally formed) element.

Also as used herein, unless otherwise specified or limited, “substantially parallel” indicates a direction that is within ±12 degrees of a reference direction (e.g., within ±6 degrees or ±3 degrees), inclusive. Similarly, “substantially perpendicular” indicates a direction that is within ±12 degrees of perpendicular to a reference direction (e.g., within ±6 degrees or ±3 degrees), inclusive. Correspondingly, “substantially vertical” indicates a direction that is substantially parallel to the vertical direction, as defined relative to the reference system (e.g., for a building, relative to a plumb vertical line as can generally correspond to the direction of in-wall studs), with a similarly derived meaning for “substantially horizontal” (relative to the horizontal direction, as can generally correspond to the direction that spaces adjacent in-wall studs apart from each other).

Some methods of the disclosed technology may be presented above or below with operations listed in a particular order. Unless otherwise required or specified, the operations of such methods can be implemented in different orders, in parallel, or as selected sub-sets of one or more individual operations (e.g., with a particular listed operation being implemented alone, rather than in combination with others).

The previous description of the disclosed embodiments is provided to enable any person skilled in the art to make or use the disclosed technology. Various modifications to these embodiments will be readily apparent to those skilled in the art, and the generic principles defined herein may be applied to other embodiments without departing from the spirit or scope of the disclosed technology. Thus, the disclosed technology is not intended to be limited to the embodiments shown herein but is to be accorded the widest scope consistent with the principles and novel features disclosed herein.

What is claimed is:

1. A support clip to secure an electrical box, the electrical box including a back wall with mounting openings, the support clip comprising:
a clip body having opposed first and second lateral edges and a top side;
first and second catch members integral with the clip body, the first catch member extending laterally outwardly and downwardly from the first lateral edge of the clip body, and the second catch member extending laterally outwardly and downwardly from the second lateral edge of the clip body,
the first and second catch members each:
including a free end with a catch that extends laterally inwardly toward the clip body, and
being resiliently movable relative to the clip body between rest orientations and installation orientations, to extend the free end through the mounting openings of the electrical box and engage the catch with an interior side of the back wall of the electrical box; and
first and second spring arms integral with the clip body, the first spring arm extending laterally outwardly and downwardly from the first lateral edge of the clip body to a first downwardly-facing seating surface, and the second spring arm extending laterally outwardly and downwardly from the second lateral edge of the clip body to a second downwardly-facing seating surface,
the first and second seating surfaces being aligned to seat on an exterior side of the back wall of the electrical box, to resiliently engage the first and second spring arms with the exterior side of the back wall of the electrical box, when the catches of the first and second catch members engage the interior side of the back wall of the electrical box.

2. The support clip of claim 1, wherein each of the first and second catch members includes:
a support arm portion angling laterally outwardly and downwardly away from the corresponding first or second lateral edge of the clip body; and
a catch arm portion that extends downwardly from the support arm portion, at a bend in the corresponding first or second catch member, and includes the catch of the corresponding first or second catch member.

3. The support clip of claim 2, wherein, for each of the first and second catch members, the catch arm portion includes a rib that extends between the bend and the free end.

4. The support clip of claim 2, wherein each of the first and second catch members includes a shoulder disposed above the catch and configured to provide a stop against insertion of the free end into the corresponding mounting opening past a maximum insertion depth.

5. The support clip of claim 1, wherein the seating surfaces curve upwardly toward free ends of the first and second spring arms.

6. The support clip of claim 1, wherein the catches are barbs that angle upwardly toward the clip body from the free end of the corresponding first or second catch member.

7. The support clip of claim 1, wherein the first and second spring arms and the clip body define a support channel configured to receive a support bar to support the support clip relative to gravity, with the catches supporting the electrical box relative to the support clip; and
wherein the first and second spring arms include protrusions that extend laterally inwardly to engage the support bar within the support channel.

8. The support clip of claim 1, wherein the first and second spring arms and the clip body define a support channel configured to receive a support bar, to support the support clip relative to gravity with the catches supporting the electrical box; and
wherein the support clip further includes locking tabs that extend integrally from the clip body to resiliently engage the support bar when the support bar is received into the support channel.

9. The support clip of claim 8, wherein the locking tabs angle downwardly relative to the clip body so as to be oriented to resiliently engage with top surfaces of the support bar.

10. The support clip of claim 8, wherein the clip body further includes a thread impression configured to receive a threaded rod to hang the support clip from the threaded rod.

11. The support clip of claim 1, wherein the first and second spring arms extend from a spring-arm portion of the clip body and the first and second catch members extend from a catch-member portion of the clip body; and
wherein the clip body defines a relief region between the spring-arm portion and the catch-member portion to provide a flex line for upward flexing of the spring-arm portion relative to the catch-member portion.

12. The support clip of claim 1, wherein the first spring arm is included in a first plurality of spring arms that extend from the first lateral edge of the clip body on opposite sides of the first catch member; and
wherein the second spring arm is included in a second plurality of spring arms that extend from the second lateral edge of the clip body on opposite sides of the second catch member.

13. A support clip to secure an electrical box, the electrical box including a back wall with mounting openings, the support clip comprising:
a clip body having opposed first and second lateral sides and a top side;
catch members integral with the clip body and extending laterally outwardly and downwardly from the first and second lateral sides, with catches that extend laterally inwardly from free ends of the catch members, the catch members being resiliently movable between rest orientations and installation orientations, to extend the catch members through the mounting openings of the electrical box and engage the catches with an interior side of the back wall of the electrical box to support the electrical box; and
spring arms integral with the clip body and extending laterally outwardly and downwardly from the first and second lateral sides, with downwardly-facing seating surfaces oriented to seat on an exterior side of the back wall of the electrical box to resiliently urge the catches into the interior side of the back wall of the electrical box.

14. The support clip of claim 13, wherein the catch members include a first catch member extending from the first lateral side of the clip body and a second catch member extending from the second lateral side of the clip body; and
wherein the spring arms include a first set of spring arms extending from the first lateral side of the clip body on opposite sides of the first catch member, and a second set of spring arms extending from the second lateral side of the clip body on opposite sides of the second catch member.

15. The support clip of claim 14, wherein the seating surfaces of the spring arms are oriented to engage the exterior side of the back wall of the electrical box at locations laterally inward from the catches, between the catches and the clip body.

16. The support clip of claim 13, wherein the support clip defines a support channel configured to receive a support bar, to support the support clip relative to gravity while the catches support the electrical box; and
wherein the support clip further includes locking tabs that extend downwardly to overlap with the support channel, to biasingly urge the clip body upwardly away from the support bar when the support bar is received into the support channel.

17. The support clip of claim 13, wherein the clip body defines a closed side of a support channel configured to receive a support bar, to support the support clip relative to gravity with the catches supporting the electrical box; and
wherein the clip body further includes a thread impression configured to receive a threaded rod to hang the support clip from the threaded rod.

18. The support clip of claim 13, wherein the catch members angle downwardly from clip body to a respective bend and extend downwardly from the respective bend to the corresponding catches; and
wherein the catches angle upwardly toward the clip body from the free end of the corresponding catch member.

19. A method of installing an electrical box, the method comprising:
providing a support clip that includes:
a clip body having opposed first and second lateral sides and a top side;
catch members integral with the clip body and extending laterally outwardly and downwardly from the first and second lateral sides, with catches that extend laterally inwardly from free ends of the catch members; and
spring arms integral with the clip body and extending laterally outwardly and downwardly from the first and second lateral sides, with downwardly-facing seating surfaces; and
decreasing a distance between the support clip and the electrical box, along an insertion direction, to:
resiliently move the catch members between rest orientations and installation orientations, to extend the catch members through mounting openings of a back wall of the electrical box and engage the catches with an interior side of the back wall of the electrical box; and
seat the seating surfaces on an exterior side of the back wall of the electrical box, to resiliently urge the catches into the interior side of the back wall of the electrical box.

20. The method of claim 19, wherein the support clip defines a support channel and further includes locking tabs that extend downwardly to overlap with the support channel; and
wherein the method further includes moving the support clip to receive a support bar into the support channel, to support the support clip relative to gravity; and
wherein engaging the catches with the interior side of the back wall of the electrical box, to support the electrical box, engages the locking tabs with the support bar to biasingly urge the clip body upwardly away from the support bar.
